(19) United States
(12) Patent Application Publication
(10) Pub. No.: US 2001/0013827 A1
(43) Pub. Date: Aug. 16, 2001

(54) Travel support system and vehicle entrance controlling system

(75) Inventor: Yasuhiko Kawano, Osaka (JP)

Correspondence Address: McDERMOTT, WILL & EMERY, 600 13th Street, N.W., Washington, DC, 20005-3096, US

(73) Assignee: Sumitomo Electric Industries, Ltd.

(21) Appl. No.: 09/781,188

(22) Filed: Feb. 13, 2001

(30) Foreign Application Priority Data
Feb. 15, 2000 (JP) 036266/2000

(51) Int. Cl. G08B 1/08

(52) U.S. Cl. 340/539; 340/928; 340/457.4; 340/5.8; 340/5.7; 340/5.6

(57) ABSTRACT

The invention relates to a travel support system and a vehicle entrance control system. The central computer comprises a service information D/B that stores information pertaining to proposable services and corresponding vehicle information pertaining to vehicles; a transmission unit that receives vehicle information from a subordinate device; and a controller that reads service information corresponding to the vehicle information received by the transmission unit from the service information D/B, wherein the transmission unit transmits the read service information to the subordinate device, and the subordinate device is provided with a ROM that stores vehicle information pertaining to vehicles, and a transmission unit that transmits the vehicle information stored in the ROM to the central computer and receives service information from the central computer. It is possible for the subordinate device to receive service information corresponding to the vehicle information stored in the ROM from the central computer.

### BACKGROUND OF THE INVENTION

1. Field of the Invention

The present invention relates to a travel support system and a vehicle entrance controlling system, and in particular to a travel support system that provides effective information to drive a vehicle, and a vehicle entrance controlling system that restricts entrance to only specified vehicles.

2. Description of the Related Arts

Although vehicles are generally parked at specified parking spaces, in some parking areas, there are limitations on the size and weight of vehicles. In particular, in multi-level parking facilities or building, due to their structure strict restrictions are imposed on the size and weight of vehicles.

Also, some parking areas or facilities for apartment houses and companies are provided with a robotized gate at the entrance, which restricts vehicles that can enter the parking areas. Such a robotized gate is opened and closed by using a remote controller. Therefore, only vehicles driven by drivers who have a remote controller are permitted to enter.

However, there are cases where although a driver operates his or her vehicle to the entrance of a parking area, parking is impossible due to the parking area being fully occupied. Also, there are cases where although a parking area is not fully occupied, restrictions on the size and weight of a vehicle are imposed on an entering vehicle as in, for example, a multi-level parking facilities or building. In such cases, the driver cannot enter if the vehicle exceeds the restriction. Such parking area restrictions cannot be conveyed a driver until he or she reaches to the entrance of the parking area. Although a driver can drive his or her vehicle to the entrance of the parking area, cases arise where entrance is not permitted. In such cases, the driver must look for another parking area. In particular, in a case where a driver learns of the restrictions of the vehicle such as size or weight for the first time just prior to entering the parking area after he or she has lined up waiting for a vacancy for a long period of time, the driver will waste time.

Also, as regards entrance control in parking facilities for apartment houses and/or companies, the driver can enter the parking facility provided that he or she has a remote controller. Therefore, a plurality of vehicles are permitted to enter the parking facility regardless of parking vacancies.

### SUMMARY OF THE INVENTION

The present invention was developed to solve these and other problems, and it is therefore an object of the invention to provide a travel support system which allows vehicles to be operated efficiently.

It is another object of the invention to provide a vehicle entrance controlling system that restricts entrance to only specified vehicles.

In order to achieve the above-described objects, one aspect of the invention is a travel support system that provides information from a central computer to a vehicle-mounted subordinate device by providing communications between the vehicle-mounted subordinate device and the central computer installed on the ground. The central computer is provided with first memory means for storing service information pertaining to proposable services corresponding to vehicle information pertaining to vehicles; means for receiving vehicle information from the vehicle-mounted subordinate device; means for reading service information corresponding to the vehicle information received by the receiving means from the first memory means; and means for transmitting the service information read by the reading means to the vehicle-mounted subordinate device; and the vehicle-mounted subordinate device is provided with second memory means for storing vehicle information pertaining to the vehicle; and communication means for transmitting the vehicle information stored in the second memory means to the central computer and for receiving service information from the central computer.

The vehicle information includes the length of a vehicle, width, height, weight, hood length, distance from the tip end of a vehicle to the driver's seat, types such as a two-seat vehicle or four-seat vehicle, etc., exhaust capacity, vehicle body number, engine model, year model, manufacturer, vehicle model, front wheel weight and rear wheel weight, vehicle brand name, grade of vehicle, torque, etc. The service information covers the contents that the vehicle driver can receive. That is, the service information includes, for example, whether parking is permitted or prohibited park the parking facility, parking charges, information on the availability of space on a ferry, etc., boarding charges, information on permission or prohibition of pass-through at a gate installed at the entrance and exit at a specified area, etc.

Wired communication or wireless communication is possible between a central computer and a vehicle-mounted subordinate device. In the case of wired transmission, for example, transmission using a serial interface such as EIA, RS-232C, Universal serial bus (USB), etc., parallel interface such as General purpose interface bus (GPIB), etc., and interface such as IEEE1394, etc., may be employed. In the case of wireless communication, for example, transmission using infrared rays such as Infrared data association (IrDA), and transmission using electromagnetic waves, etc., may be used in addition to mobile transmission means such as Personal handyphone system (PHS), Personal digital cellular (PDC), etc.

According to the invention, in the central computer, service information pertaining to proposable services is stored corresponding to vehicle information pertaining to vehicles, the service information corresponding to the received vehicle information is read, and the read service information is transmitted to a vehicle-mounted subordinate device. In the vehicle-mounted subordinate device, the stored vehicle information is transmitted to the central computer, and the service information is received from the central computer. Therefore, since a driver of the vehicle can easily know the service information corresponding to the vehicle information, it is possible to provide a travel support system which allow a vehicle to be operated efficiently.

According to another aspect of the invention, the travel support system is provided with a card having first memory means for storing vehicle information pertaining to vehicles; means for detecting the card; second memory means for storing service information pertaining to proposable services corresponding to vehicle information; first reading means for reading the vehicle information from the first memory means in response to having detected the card by the detecting means; second reading means for reading the service information corresponding to the vehicle information read by the first reading means from the second memory means; and means for outputting the service information read by the second reading means.

The card may be a magnetic card, an IC card, or other known equivalent. The first memory means may comprise a storing medium utilizing a magnet and semiconductor memory such as a read-only-memory (ROM) or a random-access-memory (RAM), etc.

The outputting means may comprise an indicating device such as a display, a lamp, etc., or a printing device such as a printer. The output of service information may include a mode of displaying the service information on a display, a mode of lighting lamps, a mode of printing out the information on a specific form, etc.

According to the invention, the first memory means of the card stores vehicle information pertaining to the vehicle and the second memory means stores the service information pertaining to proposable services corresponding to the vehicle information. The service information corresponding to the vehicle information read from the first memory means is read from the second memory means and is output, whereby it is possible to provide a travel support system which allows the driver to operate a vehicle efficiently since the driver can have easy access to the service information corresponding to the vehicle information.

According to still another aspect of the invention, a travel support system is provided with first memory means for storing vehicle information pertaining to vehicles; means for acquiring the present position of a vehicle; second memory means for storing information on the locations of a plurality of parking areas and contents of proposable services for the respective parking areas corresponding to vehicle information; means for selecting an adequate parking area from the second memory means based on the vehicle information stored in the first memory means and the present vehicle position acquired by the acquiring means; and means for notifying information on the location of available parking area, which is selected by the selecting means.

The notifying means may comprise an indicating device such as a display, an audio outputting device such as a speaker, and a printing apparatus such as a printer, etc.

According to the invention, the second memory means stores information on the locations of parking facilities and the contents of the services proposed by the respective parking facilities corresponding to the vehicle information, and based on the vehicle information and present vehicle position, an adequate parking facility can be selected from the second memory means and communicated to the driver, whereby it is possible to provide a travel support system by which the driver can operate a vehicle efficiently since the driver can easily determine the nearest available parking facility on the basis of the vehicle information and the present position of the vehicle.

According to still another aspect of the invention, a vehicle entrance controlling system for permitting the entrance or pass-through of a vehicle by communication between a vehicle-mounted subordinate device and the central computer placed on the ground; wherein the vehicle-mounted subordinate device is provided with first memory means for storing vehicle information pertaining to the vehicle; second memory means for storing information about an individual pertaining to the owner of a vehicle; and means for transmitting the vehicle information stored in the first memory means and information about an individual stored in the second memory means to the central computer; and the central computer is provided with a gate that permits or prohibits a vehicle to pass through; third memory means for storing information showing permission or prohibition of the pass-through of a vehicle, corresponding to the information about an individual and vehicle information; means for receiving the vehicle information and information about an individual that are transmitted from the transmitting means; means for reading the information showing permission or prohibition of the pass-through of a vehicle corresponding to the vehicle information and information about an individual that are received by the receiving means; and gate controlling means for changing the status of the gate in response to the information showing permission or prohibition, which is read by the reading means.

The information on an individual includes the name of the vehicle owner, the name of the vehicle driver, the number of number plates attached to the vehicle, telephone number, address, etc.

According to the invention, first memory means of the vehicle-mounted subordinate device stores vehicle information, the second memory means stores information about an individual by which the vehicle can be distinguished from other vehicles, and the vehicle information and information on an individual are transmitted to the central computer by the transmitting means. The reading means of the central computer reads the information on permission or prohibition of pass-through with respect to the received vehicle information and information on an individual from the third memory means, wherein the gate is controlled by the gate controlling means in response to the read information on permission or prohibition of pass-through, and the gate is opened and closed based on the vehicle information and the information on the individual. Therefore, it is possible to provide a vehicle entrance controlling system that allows only specified vehicles to pass through.

### BRIEF DESCRIPTION OF THE DRAWINGS

FIG. 1 is a block diagram showing a general configuration of a travel support system according to a first embodiment of the invention;

FIG. 2 is a view showing one example of entered status data stored in a service information D/B 23 of the travel support system according to the first embodiment;

FIG. 3 is a flow chart showing a process flow carried out by a subordinate device 10 of the travel support system according to the first embodiment;

FIG. 4 is a flow chart showing a process flow carried out by a central computer 20 of the travel support system according to the first embodiment;

FIG. 5 is a flow chart showing an updating process flow carried out by a central computer 20 of the travel support system according to the first embodiment;

FIG. 6 is a block diagram showing a general configuration of a travel support system according to a second embodiment of the invention;

FIG. 7 is a flow chart showing a process flow carried out by a central computer 30 of the travel support system according to the second embodiment;

FIG. 8 is a block diagram showing a general configuration of a travel support system according to a third embodiment;

FIG. 9 is a view showing one example of parking facility data stored in a parking D/B 43 of the travel support system according to the third embodiment;

FIG. 10 is a flow chart showing a process flow carried out by the travel support system according to the third embodiment;

FIG. 11 is a block diagram showing a general configuration of a travel support system according to a fourth embodiment;

FIG. 12 is a view showing one example of parking facility data stored in a parking D/B 43 of the travel support system according to the fourth embodiment;

FIG. 13 is a flow chart showing a process flow carried out by a subordinate device 40A of the travel support system according to the fourth embodiment;

FIG. 14 is a flow chart showing a process flow carried out by a central computer 50 of the travel support system according to the fourth embodiment;

FIG. 15 is a block diagram showing a general configuration of a vehicle entrance controlling system according to a fifth embodiment;

FIG. 16 is a perspective view of a gate robot 71 of the vehicle entrance controlling system according to the fifth embodiment;

FIG. 17 is a flow chart showing a process flow carried out by the subordinate device 60 of the vehicle entrance controlling system according to the fifth embodiment; and

FIG. 18 is a flow chart showing a process flow carried out by the central computer 70 of the vehicle entrance controlling system according to the fifth embodiment.

### DESCRIPTION OF THE EMBODIMENTS

Hereinafter, a description is given of embodiments of the invention with reference to the accompanying drawings. Also, in the drawings, the same reference numbers indicate the same or similar members, and overlapping descriptions thereof are omitted.

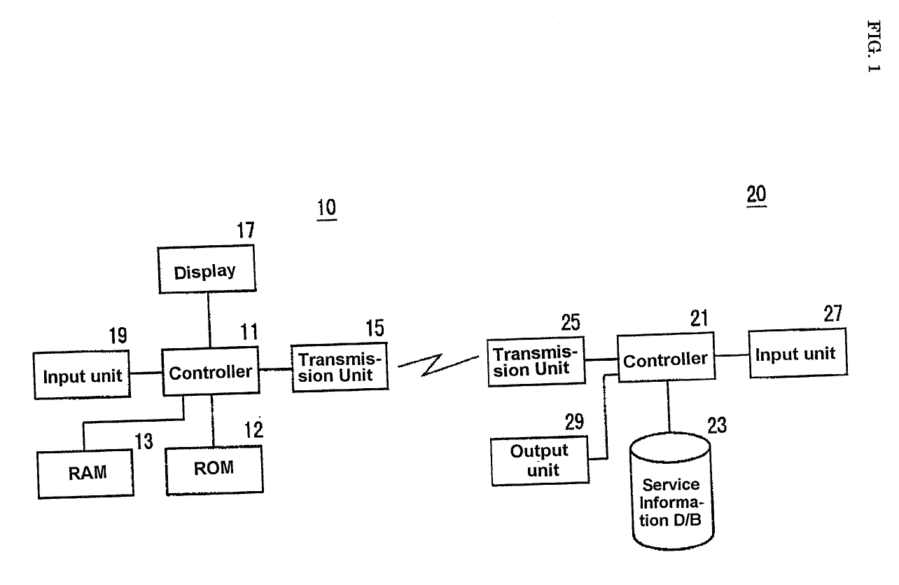

FIG. 1 is a block diagram showing a general configuration of a travel support system according to the first embodiment. The travel support system according to the first embodiment comprises a vehicle-mounted subordinate device 10 and a central computer 20 installed on the ground.

The subordinate device 10 includes a controller 11 to control the entire subordinate device 10, a read-only-memory (hereinafter called a “ROM”) 12 to store the vehicle information, a random-access-memory (hereinafter called a “RAM”) 13 to store information on an individual, a transmission unit 15 to communicate with the central computer, a display 17 to show a driver specified information, and an input unit 19 to input specified information in the subordinate device 10.

The controller 11 may comprise a central processing unit (CPU), a microprocessor, etc. The ROM 12 is a semiconductor memory and stores the vehicle information and programs to be executed in the controller 11.

The vehicle information includes the length of a vehicle, width, height, weight, hood length, distance from the tip end of a vehicle to the driver's seat, type such as a two-seat vehicle or four-seat vehicle, etc., exhaust capacity, vehicle body number, engine model, year model, manufacturer, vehicle model, front wheel weight and rear wheel weight, vehicle brand name, grade of vehicle, torque, etc. The vehicle information does not change from production of the vehicle to disposal thereof. Therefore, it is preferable to store the vehicle information in an unwritable ROM.

The RAM 13 is a semiconductor memory and stores information on an individual. The information on an individual includes, for example, the name of the vehicle owner, the name of the vehicle driver, the license plate number attached to the vehicle, telephone number, address, etc. The information on an individual is subject to changes whenever the vehicle owner changes, and can be modified by inputting from the input unit 19 described later. Therefore, it is preferable to store the information in a RAM.

The display 17 may be a cathode-ray tube, liquid crystal display, plasma display, etc. Specified information is displayed on the basis of instructions from the controller 11. The driver can visibly recognize the information displayed on the display 17.

The input unit 19 may be a keyboard, touch panel, or button switch by which the driver inputs specified information in the subordinate device 10. Particularly, if a touch panel is used in combination with the display 17, alphanumeric, KANJI, KATAKANA, and HIRAGANA characters can be input.

The transmission unit 15 communicates with the transmission unit 25 of the central computer 20 described later. The transmission unit 15 can communicate with the transmission unit 25 by using, for example, mobile transmission such as PHS, PDC, GSM, etc., infrared rays such as IrDA, or electromagnetic waves.

Further, the transmission unit 15 is not limited to a wireless method, and it may be subjected to wired transmission. In the case of the wired transmission, the transmission unit 15 may employ a serial interface such as EIA, RS-232C, USB, etc., a parallel interface such as GPIB, etc., or an interface such as IEEE1394, etc.

A description is given with reference to FIG. 1(B). The central computer 20 includes a controller 21 to control the entire central computer, a service information database (hereinafter called a “service information D/B”) 23 that stores service information pertaining to proposable services with respect to the vehicle information, a transmission unit 25 that communicates with the subordinate device 10, an input unit 27 to input information in the central computer 20, and an output unit 29 to output specified information.

The controller 21 is composed of a CPU, microprocessor, etc. The service information D/B 23 stores the contents of the proposable services with respect to the vehicle information. The contents of the services show the availability of parking space and parking charges, etc., in the service that provides drivers with parking space information in a parking facility, information showing whether or not a specified vehicle can board a ferry, time of the next available ferry, and boarding charges in the service of transporting vehicles by ferries, and information on the permission or prohibition of a pass-through gate in the service of permitting vehicles to enter an specified area in a fee-charging facility.

The input unit 27 is composed of a keyboard to input specified information into the central computer 20 and an input device, etc., to input the outputs of a sensor. In more detail, in a service that provides parking spaces in a parking facility, the availability of respective parking spaces is detected by a sensor, and the detected information is input into a controller 21 by the input device.

The controller 21 updates the service information stored in the service information D/B 23 based on the information input by the input unit 27. Thereby, the service information stored in the service information D/B 23 can be updated to the latest information.

The output unit 29 is composed of a printer, a display, or a lamp, etc. Specified information is output from the output unit 29 in compliance with instructions given by the controller 21. For example, where the proposed service is the lending of a parking space, if parking space is available, “Vacancy” is displayed on a display or a blue light is illuminated. To the contrary, if no parking space is available, a character “Occupied” or “Full” is displayed on the display, or a red light is illuminated.

The transmission unit 25 communicates with the transmission unit 15 of a subordinate device 10. The transmission unit 25 may be wired or wireless. The transmission unit 25 may be similar to the configuration on the transmission unit 15 of the subordinate device 10.

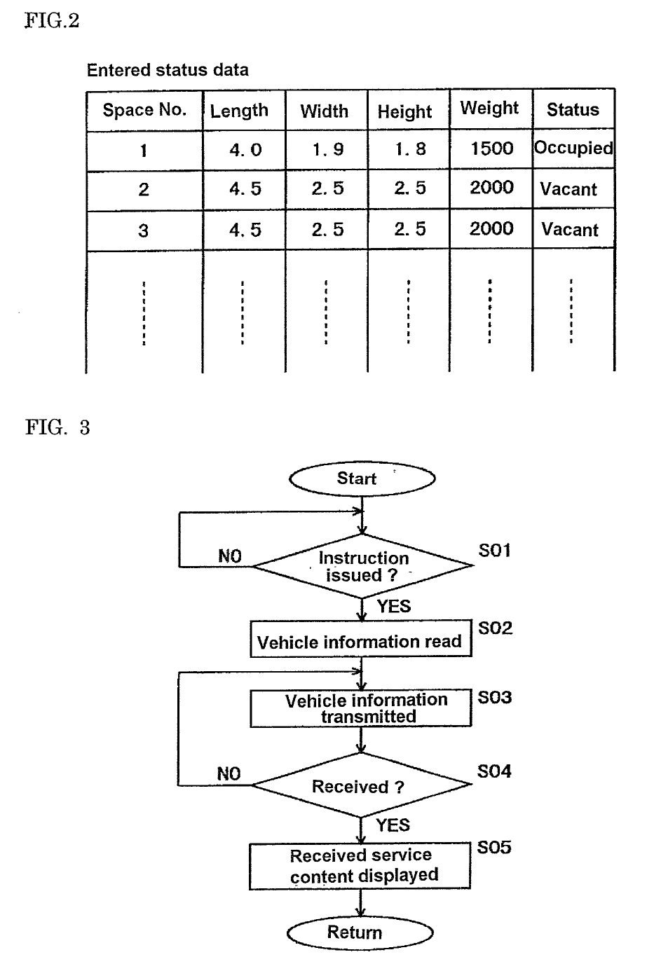

Next, a description is given of a travel support system in the case where the proposed service is the lending of a parking space. In this case, it is assumed that the service information is that showing the availability of sparking space. In this case, the central computer 20 may be installed in the parking facility or at a roadside of the surrounding roads near the entrance of the parking facility. FIG. 2 is a view showing one example of entered status data stored in the service information D/B 23 of a travel support system according to the first embodiment. A description is given below based on FIG. 2. The entered status data are expressed in terms of space numbers, which are numbers attached to parking spaces, length, width, height, weight, and status particulars. For example, the entered status data of space No. 1 are length of 4.0[m], width of 1.9[m], height of 1.8[m], weight of 1500[Kgs], and status [Occupied].

An item comprising the status shows whether or not a vehicle has entered and the space is occupied, wherein, if the item is [Occupied], a vehicle already occupies the parking space, and another vehicle cannot enter, and if the item is [Vacancy], the parking space can accepted the entering of a vehicle.

Therefore, the entered status data include data regarding the size and weight of vehicles that are permitted to enter, and become the data showing whether or not a vehicle is parked in respective parking spaces. Thus, if the size and weight of a vehicle are determined from the entered status data, it is possible to acquire information on the availability of space where a specified vehicle can be parked or is permitted to enter.

FIG. 3 is a flow chart showing a process flow carried out by a subordinate device 10 in the travel support system according to the first embodiment. The process flow is described on the basis of FIG. 3. The subordinate device 10 judges whether or not a specified instruction is input by a driver by using the input unit 19 (Step S01). The judgment is executed by pressing or not pressing a designated key of the keyboard of the input unit 19. Also, it may be a construction in which a button switch is provided instead of the keyboard, and whether or not any specified instruction is input by a driver is judged on the basis of whether or not the button switch is turned on.

Where it has been judged in Step S01 that any instruction is issued, the process proceeds to Step 02. If not, the process waits until instructions are given. Also, in the flow chart, although the process remains pending until instructions are given by the input unit 19, an interrupt signal may be generated by the input of other instructions, and the subsequent processes may be carried out on the basis of the interruption.

In Step S02, the vehicle information is read from the ROM 12. And, the read vehicle information is transmitted to the central computer 20 via the transmission unit 15 (Step S03). Where the transmission unit 15 is composed of a mobile transmission device or a satellite transmission device, the vehicle information is transmitted after connection is established with the transmission unit 25 of the central computer 20. Also, where the transmission unit 15 is composed of infrared rays or electromagnetic waves, the vehicle information is transmitted directly to the central computer. In addition, where the transmission unit 15 is composed of a wired system, the vehicle information is transmitted to the central computer after a driver connects the transmission unit 15 to the transmission unit 25 of the central computer 20 by using a connection cable, etc.

Also, the transmission unit 15 judges whether or not information is received from the central computer 20 (Step S04). Where information is received, the process shifts to Step S05, and where no information is received, the process shifts to Step S03, wherein the transmission of the vehicle information is repeated. Thus, by repeating the transmission of the vehicle information, since re-transmission is enabled if any transmission trouble occurs between the subordinate device 10 and the central computer 20, the transmission is reliable.

In Step S05, the service content received by the transmission unit 15 is displayed on the display 17. In the embodiment, the service content received by the transmission unit 15 pertains to the availability of a parking space where the vehicle desires to park, for example, [Parking Acceptable] is displayed on the display 17 when a parking space is available. If not, [No Parking Space Available] is displayed thereon. Further, where the vehicle exceeds the height or weight limitation, or there is no available parking space that can accommodate the vehicle in terms of the physical limitations of the vehicle, [Limit Over] is displayed thereon. Also, a speaker may be provided instead of the display 17, and these prompts may be output by audio communication through the speaker.

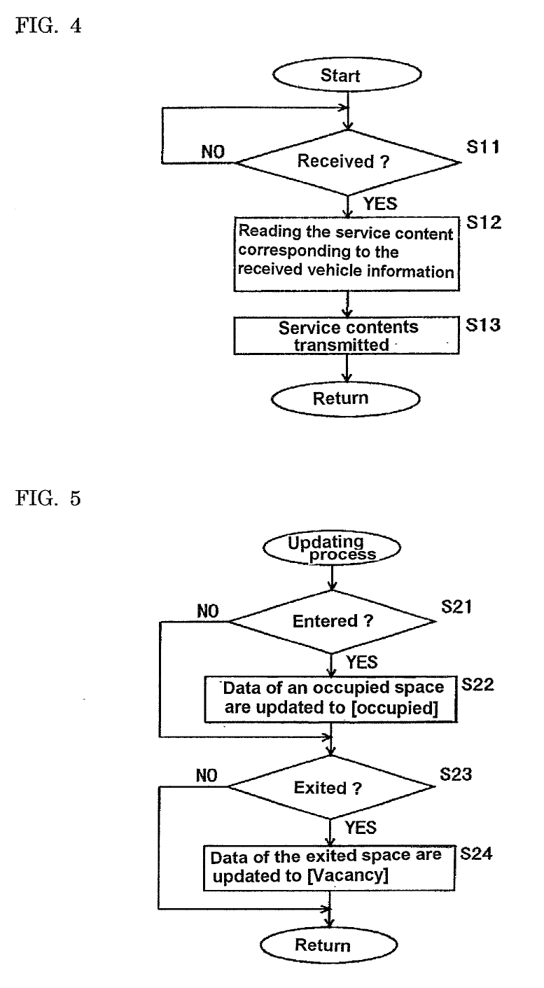

FIG. 4 is a flow chart showing a process flow executed by the central computer 20 of the travel support system according to the first embodiment. The process flow is described below on the basis of FIG. 4. The central computer 20 judges whether or not the transmission unit 25 receives the vehicle information from a subordinate device 10. Herein, the vehicle information covers the length, width, height and weight of the vehicle.

The process shifts to Step S12 where the transmission unit 25 receives the vehicle information. If no vehicle information is received, the process waits pending until the information is received. Also, in the embodiment, although the transmission unit 25 is constructed so as to remain pending until any vehicle information is received from the subordinate device, it may be of a construction in which an interruption is generated when receiving the vehicle information and the subsequent processes are carried out.

In Step S12, the service content corresponding to the received vehicle information is read from the service information D/B 23. In mode detail, the service information D/B 23 stores the entered status data shown in FIG. 2, wherein the space number where the vehicle can be parked is extracted on the basis of the received vehicle information. And, the controller judges whether or not there exist any data in which the [status] item of the data of the extracted space number is [Vacancy].

Where any data in which the [status] item of the data of the extracted space number is [Vacancy] when the space number, at which a vehicle can be parked, corresponding to the vehicle information received by the transmission unit 25 has been extracted, the service content is made into [Enter Acceptable]. If no [Vacancy] data exists in the item of [status] in the data of the extracted space number, the service content is made into [No Entry Permitted]. Also, if any space number where a specified vehicle can be parked is not extracted, corresponding to the received vehicle information, this means that the vehicle is oversize, or overweight, that is, there is no space where the vehicle can be physically parked. In this case, the service content is made into [Limit over]

The service content read by the transmission unit 25 is transmitted to the subordinate device 10 (Step S13).

FIG. 5 is a flow chart showing a renewal processing flow carried out by the central computer of the travel support system according to the first embodiment. In the renewal process herein, the contents of the data of the service information D/B 23 are updated. By this process, the data of [status] in the parking status data shown in FIG. 2 are rewritten. A sensor that can detect whether or not a vehicle is parked is provided in respective parking spaces in a parking area, and an entering signal or an exiting signal of the sensor is input in the input unit 27.

In the renewal process, the input unit 27 judges whether or not an entering signal of the sensor is input. Where an entering signal is input, it is judged that a vehicle is parked in the space, and the process shifts to Step 22. Where no entering signal issued, the process shifts to Step S23. In Step S22, the item of [status] of the data of the space number where a vehicle entered is updated to [Occupied] in the entered status data.

Next, in Step S23, it is judged whether or not an exiting signal of the sensor is input in the input unit 27. Where an exiting signal is input, it is judged that a vehicle has exited. The process shifts to Step S24, where no exiting signal is input, and the process is terminated. In Step S24, in the entered status data, the item of [status] of the data of the space number that has become vacant is updated to [Vacancy].

Thus, by this process, the data of entered status data are revised to be updated to the latest status in real time.

As described above, in the travel support system according to the first embodiment, since a vehicle-mounted subordinate device 10 transmits the vehicle information to the central computer 20, the display 17 shows whether or not the vehicle can be parked in the parking facility. Therefore, it is possible for the driver to immediately determine whether the driver can park the vehicle in the parking facility or whether the driver must search for another parking facility. In particular, where the entrance of the parking facility cannot be seen, and it is unclear as to whether the vehicle exceeds the size or weight restriction, it is possible for the driver to obtain information on the availability of parking space without approaching the entrance of the parking facility.

In the present embodiment, although it is constructed that the service contents are transmitted from the central computer 20 to a subordinate device 10, the output unit 29 may be composed of lamps, LED display plate, or liquid crystal display, etc., and the above-described contents may be displayed on the output unit 29, which allows a vehicle driver to determine whether the vehicle can be parked, on the basis of the output result of the output unit 29.

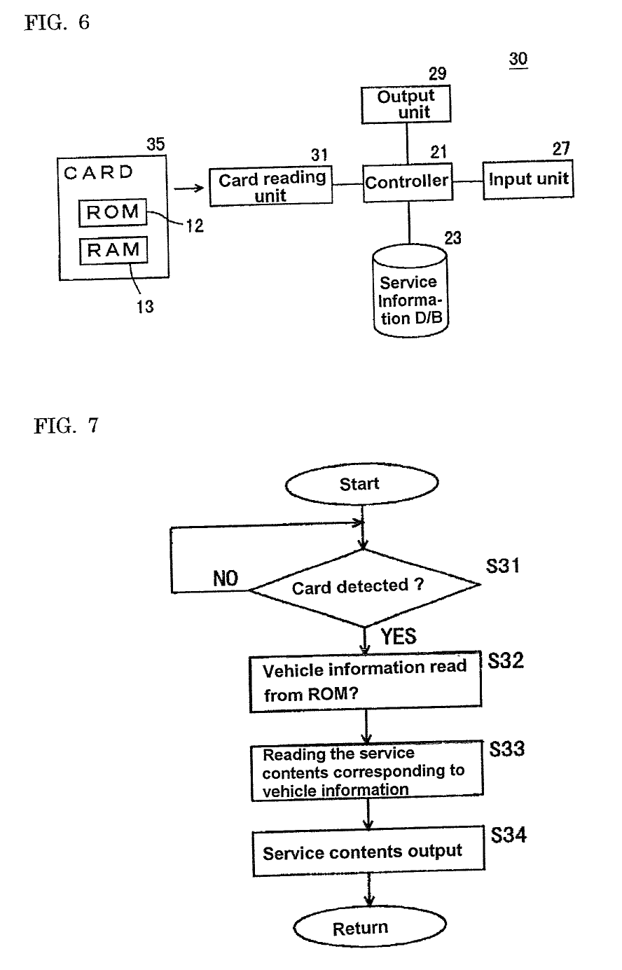

FIG. 6 is a block diagram showing a general configuration of a travel support system according to a second embodiment. The travel support system according to the second embodiment is composed of an IC card 35 and a central computer 30. The IC card 35 includes a ROM 12 that stores vehicle information, and a RAM 13 that stores information on an individual. The central computer 30 includes a controller 21 to control the entirety of the central computer 30, a service information D/B 23 that stores the service information, an input unit 27 by which specified information is input, an output unit 29 that outputs specified information based on instructions of the controller 21, and a card reading unit 31 that reads information stored in the ROM 12 or RAM 13 of the IC card 35.

The ROM 12 of the IC card 35 stores vehicle information, and the RAM 13 stores information on an individual. Further, the vehicle information and information on an individual may be stored in either of the ROM 12 or the RAM 13. Also, a magnetic card that can store the vehicle information and information on an individual as magnetic information may be used instead of the IC card 35.

The output unit 29 is composed of a display or a printer that can print out specified information. The card reading unit 31 reads the vehicle information and information on an individual from the ROM 12 and RAM 13 of the IC card 35. The reading is carried out by a method that brings the IC card 35 into contact with the card reading unit 31. In addition, such a reading method may be employed which can read information without bringing the IC card 35 and the card reading unit 31 into contact with each other.

Hereinafter, a description is given of a case where the travel support system according to the second embodiment is applied to the provision of service information in a ferry boarding procedure. In this case, it is preferable that the central computer 30 be installed on the ground at the roadside near the ferry boarding entrance. It may also be installed at the reception counter for ferry boarding procedures.

The service information D/B 23 stores the number of boardable vehicles in terms of the length, width, height, and weight of the vehicles, and information pertaining to boarding charges, etc. These types of information are stored foe each ferry. The ferries are specified in terms of departure times.

FIG. 7 is a flow chart showing a process flow carried out by the central computer 30 in the travel support system according to the second embodiment. A description is given below based on FIG. 7. First, the card reading unit 31 determines whether or not a card is detected (Step S31). Where the card is detected, the process shifts to Step S32, and if not, the process stands by until a card is detected.

In Step S32, vehicle information is read by the card reading unit 31 from the ROM 12 of the IC card 35, and information showing the service content corresponding to the read vehicle information is read from the service information D/B 23 (Step S33).

The data stored in the service information D/B 23 includes the number of vehicles in terms of the length, width, height, and weight of vehicles with respect to the departure times of ferries.

The vehicle information stored in the ROM are the length, width, height and weight of vehicles. The information showing the service content read in Step S33 is the departure time of a ferry on which a vehicle can be boarded. It is determined by retrieving the service information D/B 23. The retrieval is commenced from the data of ferry whose departure time comes earliest from the present time. The number of vehicles that can be boarded, corresponding to the vehicle information read from the ROM 12 is retrieved. If there is only one available space for a vehicle to be boarded, the information on the time of the ferry can be read as the service content. Also, information on the boarding charge corresponding to the vehicle information can be read out as the service content.

The service contents consisting of the information on the time of a ferry on which the vehicle can be boarded and information on the boarding charge are printed out by a printer of the output unit 29 on specified forms such as the required documents for boarding together with the vehicle information (Step S34).

Further, where the information on an individual is read from the RAM 13 of the IC card 35 by the card reading unit 31, the information on an individual such as the name of the driver may be printed out from a printer of the output unit 29 as a passenger.

As described above, in the travel support system according to the second embodiment, by the central computer 30 reading the vehicle information stored in the IC card 35, the service contents which corresponds to the vehicle information, such as the time of a ferry on which a vehicle can be boarded, and information on the boarding charges are printed out. Therefore, by causing the vehicle information stored in the IC card 35 to be read by the central computer 35, the driver can receive the service contents corresponding to the vehicle that he or she drives. Thus, the driver can instantaneously estimate the time of the ferry where he or she can board together with the vehicle allowing the driver to drive efficiently.

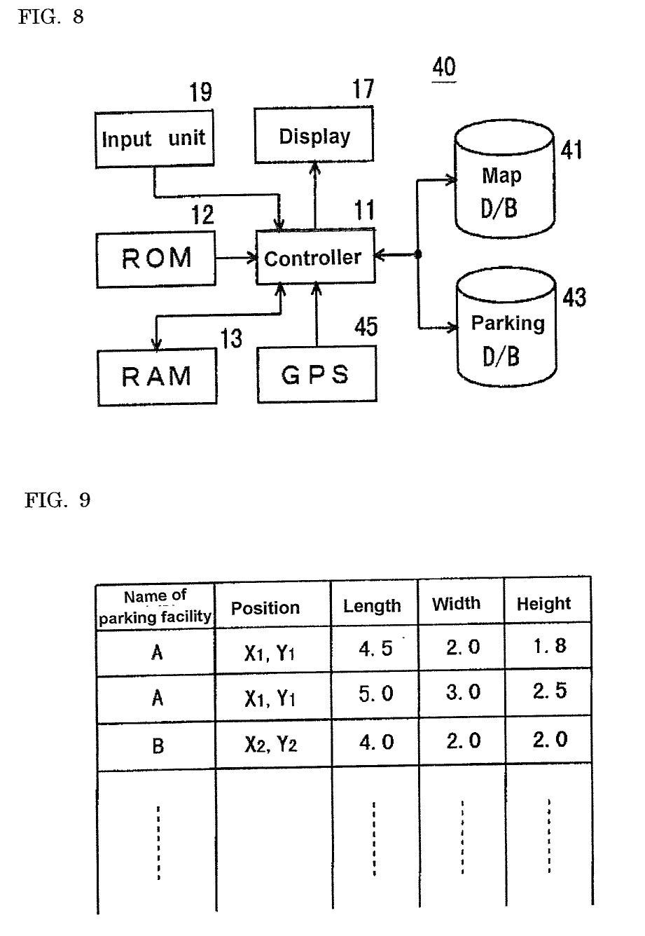

FIG. 8 is a block diagram showing a general configuration of a travel support system according to a third embodiment. The travel support system is described below on the basis of FIG. 8. The travel support system 40 comprises a controller 11 to control the entirety of the travel support system 40, a ROM 12 to store vehicle information, a RAM 13 to store information on an individual, a display 17 to display specified information based on instructions from the controller 11, an input unit 19 to input specified information into the travel support system 40, a global positioning system (hereinafter called a “GPS”) 40 to acquire the current position of a vehicle, a map data base (hereinafter called a “map D/B”) 41 to store the map data, and a parking facility data base (hereinafter called a “parking D/B”) 43 to store the parking facility data.

The map D/B 41 stores the road map data. The controller 11 reads the data of the map D/B 41, and the read map data are displayed on the display 17. The parking D/B 43 stores data such as the names of parking facilities, positions on the map, and size restrictions of vehicles that can be parked, etc. The map D/B 41 and parking D/B 43 may be data recorded in a recording medium such as a compact disk and a digital video disk, etc. In this case, it may be constructed that the data recorded in these recording media can be read by using a reading unit in the controller 11.

The GPS 45 acquires the current position of a vehicle by utilizing electric waves from artificial satellites. The controller 11 notifies the driver of the current position of his or her vehicle by marking it on the map displayed on the display 17 on the basis of the current position transmitted from the GPS 45.

FIG. 9 is a view showing one example of parking facility data stored in the parking D/B 43 of the travel support system according to the third embodiment. A description is given below on the basis of FIG. 9. The parking facility data consist of the name of a parking facility, location of the parking facility, and the length, width, and height of vehicles that can be accommodated. Also, instead of establishing the length, width and height of vehicles, the size of spaces in the parking facility, that is, the data may be established as the length, width and height of the spaces.

For example, in the example of the parking facility shown in FIG. 9, the parking facility “A” is located at the position expressed in terms of the coordinates (X1, Y1) on the map, which shows that vehicles having a length of 4.5[m], width of 2.0[m] and height of 1.8[m] and vehicles having a length of 5.0[m], width of 3.0[m] and height of 2.5[m] may be accommodated.

Thus, the parking facility data stored in the parking D/B 43 consists of locations of parking facilities on the map, lengths, widths and heights of vehicles that can be accommodated in respective parking facilities with respect to a plurality of parking facilities. Therefore, where the current position of a specified vehicle is determined, it is possible to extract parking facilities existing in an area within a specified distance from the location from the parking D/B. Further, it is possible to extract a parking facility where the vehicle can be parked or accommodated, from the vehicle information consisting of the length, width, and height of the vehicle.

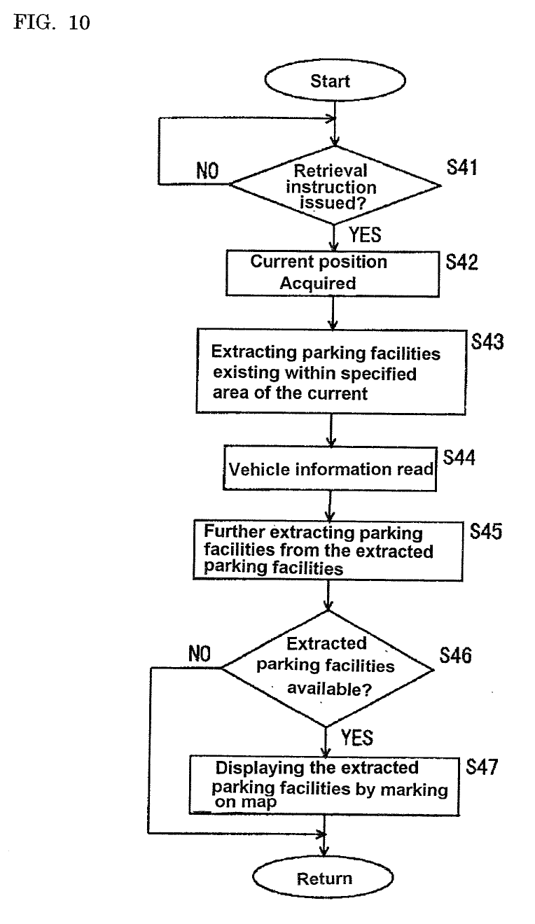

FIG. 10 is a flow chart showing a process flow carried out by the travel support system according to the third embodiment. A description is given below based on FIG. 10. The travel support system 40 determines whether or not an instruction is issued from the input unit 19 with respect to retrieval of a parking facility (Step S41). If the retrieval instruction is issued, the process shifts to Step S42, and if not, the process stands by until such instruction is issued. Also, where such instruction is issued, it is processed as an interrupt process that carries out the processes after Step S42.

In Step S42, the current position of the vehicle is acquired by the GPS 45. By using the parking D/B 43, parking facilities existing in an area within a specified range from the acquired present position of the vehicle are extracted. The specified range can be set by inputting data through the input unit 19. In Step S43, the parking facilities are extracted based on the data of the item [Position] of the parking data stored in the parking D/B 43 shown in FIG. 9.

The vehicle information is read from the ROM 12 (Step S44). The vehicle information read herein includes the length, width and height of the vehicle.

A parking facility corresponding to the vehicle read in Step S44 is further extracted from the parking facilities extracted in Step S43 (Step S45). The extraction in Step S45 is such that a parking facility having a larger space than the data of the vehicle information is extracted by comparing the parking data with the vehicle information in terms of [length], [width] and [height].

It is judged whether or not the extracted parking facility is available (Step S46). Then, the process shifts to Step S47. If not, the process is terminated. Through the processes described in Step S43 through Step S46, an adequate parking facility is extracted.

In Step S47, the extracted parking facility is marked on the map and is displayed on the display 17, whereby the driver is able to simultaneously confirm both the present position of his or her vehicle and the location of the parking facility having available parking space, which allows the driver to drive the vehicle efficiently.

Also, in Step S46, although it is constructed that the process is terminated when there is no available parking facility, by widening the specified range in Step S43, the processes subsequent to Step S43 may be repeated.

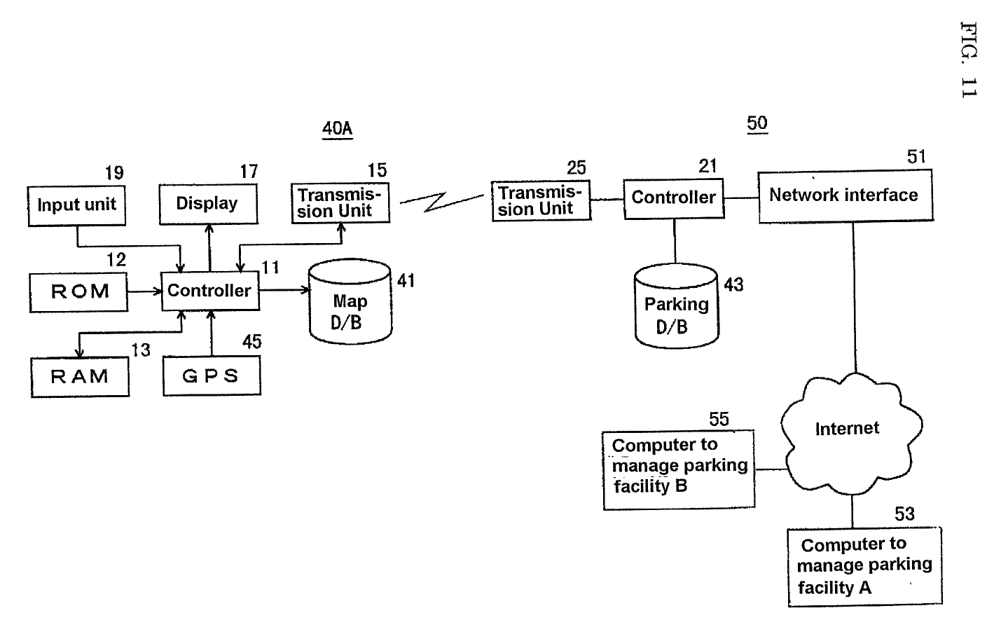

FIG. 11 is a block diagram showing a general configuration of a travel support system according to a fourth embodiment. The travel support system according to the fourth embodiment comprises a vehicle-mounted subordinate device 40A and a central computer 50 installed on the ground.

The subordinate device 40A comprises a controller 11 to control the entirety of the subordinate device 40A, a ROM 12 to store vehicle information, a RAM 13 to store information on an individual, a transmission unit 15 to communicate with the central computer 50, a display 17 to display specified information based on instructions from the controller 11, an input unit 19 to input specified information in the subordinate device 40A, a map D/B 41 to store map data, and a GPS 45 to acquire the current position of a vehicle.

The central computer 50 includes a controller 21 to control the entirety of the central computer, a transmission unit 25 to communicate with the subordinate device 40A, a parking D/B 43 to store the parking facility data, and a network interface 51 to communicate with peripheral computers via the Internet.

The network interface 51 is a communication interface that connects the controller 21 to the Internet to enable the controller 21 to communicate with a peripheral computer, etc., via the Internet. Control computers 53 and 55 to manage the parking facilities are connected to the Internet. Also, although two control computers to manage the parking facilities are shown in the drawing, it is actually more preferable that as many control computers as possible be connected to the Internet.

Also, in the embodiment, although the network to which the controller 21 is connected via the network interface 51 is made into the Internet, it is not limited to the Internet. The network may be public telephone lines, exclusive lines, or local area network, etc.

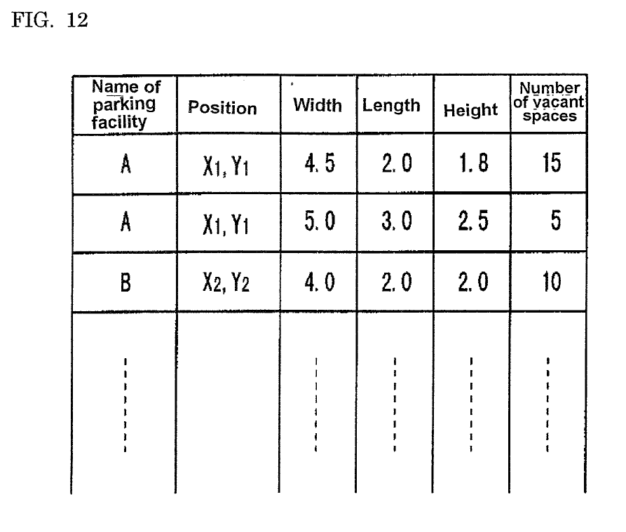

FIG. 12 is a view showing parking facility data stored in the parking D/B 43 of the travel support system according to the fourth embodiment. A description is given below based on FIG. 12. The parking facility data consist of names of parking facilities, locations, and the length, width, height and number of spaces that can accommodate the vehicles. For example, in the example of the parking facility data shown in FIG. 12, the parking facility “A” is located at the position expressed in terms of the coordinates (X1, Y1) on the map, and it is shown that fifteen vehicles having a length of 4.5[m], width of 2.0[m] and height of 1.8[m]. and five vehicles having a length of 5.0[m], width of 3.0[m] and height of 2.5[m] may be accommodated.

Therefore, it is possible to extract the names and positions of the parking facilities that exist within a specified range from the present position of a vehicle. The data can also show the number of vehicles that can be accommodated therein, based on the vehicle information consisting of the length, width and height of vehicles.

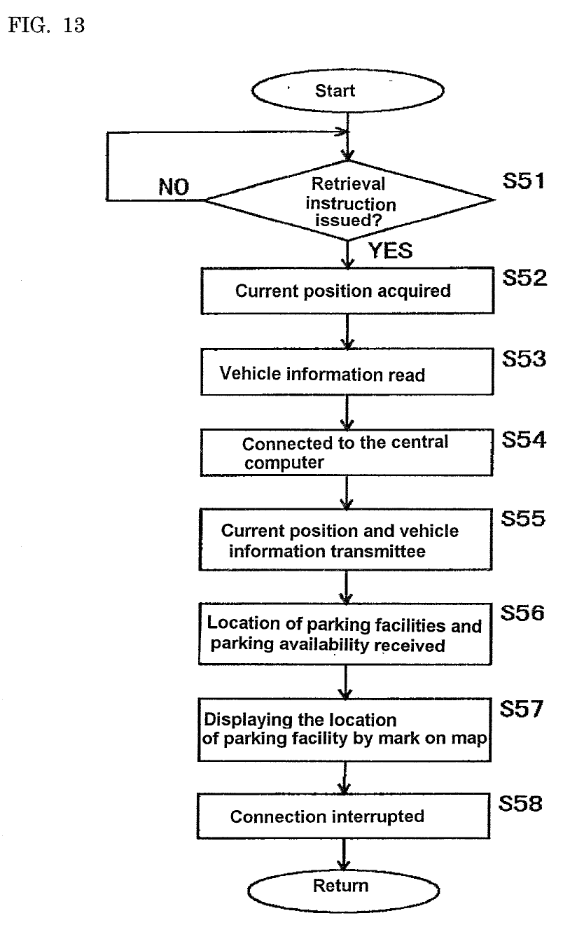

FIG. 13 is a flow chart showing a process flow carried out at the subordinate 40A of the travel support system according to the fourth embodiment. A description is given below based on FIG. 13. In the subordinate device 40A, the controller determines whether or not the input unit 19 issues an instruction for retrieving a parking facility (Step S51). If a retrieving instruction is issued, the process shifts to Step S52, and if not, the process stands by until any retrieving instruction is made. Also, in the embodiment, although the process is constructed so as to stand by until a retrieving instruction is issued, an interrupt signal is generated when a retrieving instruction is issued, wherein the processes after Step S52 may be executed.

In Step S52, the present position of a vehicle is acquired by the GPS 45. And, the vehicle information consisting of the length, width and height of a vehicle is read from the ROM 12 (Step S53).

Next, the transmission unit 25 of the central computer 50 is connected to a transmission line via the transmission unit 15 (Step S54). In the embodiment, mobile transmission is assumed as the transmission between the transmission unit 15 and transmission unit 25. Therefore, the transmission units 15 and 25 may employ a mobile transmission device such as PHS, PDC or GSP, or a satellite communication system.

Where the central computer is connected to a transmission line, the present position of the vehicle acquired in Step S52 and the vehicle information read in Step S53 are transmitted to the central computer 50 (Step S55).

The location of the parking facilities where a vehicle can be parked, and information on whether or not the vehicle can be accommodated are received from the central computer 50 (Step S56). The location of parking facilities received herein is the location of the parking facilities where the vehicle can be accommodated, regardless of whether or not the parking facilities are occupied, and the information on whether or not the vehicle can be accommodated is information on whether the parking facility is occupied or vacant.

In Step S57, a designated mark is provided on the location of the facility received in Step S56 on the map displayed on the display 17. The mark is, for example, a circle in blue at the location where parking is available and an “X” in red where the parking facility is occupied and no parking is available.

And, the connection between the transmission unit 15 and transmission unit 25 is cut off (Step S58), and the process is terminated.

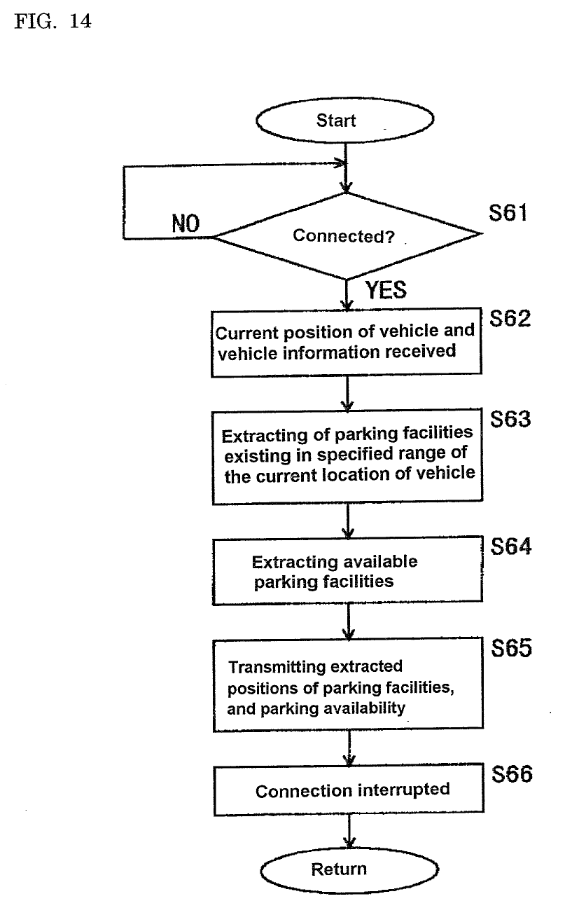

FIG. 14 is flow chart showing a process flow carried out by the central computer 50 of the travel support system according to the fourth embodiment. A description is given below based on FIG. 14. The transmission unit 25 of the central computer 50 determines whether or not an external connection request is issued from a subordinate device 40A (Step S61). Where a circuit is connected by the connection request, the process shifts to Step S62. If not, the process stands by until a connection request is made. Also, by generating an interrupt signal when a connection request is made, the processes after Step S62 may be executed.

In Step S63, the transmission unit 25 receives the current position of the vehicle and the vehicle information from the subordinate device 40A. The vehicle information received herein includes the length, width and height of the vehicle.

And, all the parking facilities existing in a specified range from the received current position of the vehicle are extracted from the parking facility data stored in the parking D/B 43 (Step S63). These parking facilities are extracted by using the data of the items regarding [positions] of the parking facility data shown in FIG. 12.

Next, a parking facility corresponding to the vehicle information is further extracted from the parking facilities extracted in Step S63 (Step S64). The parking facility corresponding to the vehicle information is selected by extracting a parking facility having less stringent overall restrictions on the length, width and height from the data shown in FIG. 12 than those of the vehicle information. And, the controller determines whether or not parking is available. Parking availability is determined based on the [Number of vacant spaces] item of the extracted parking facility data. Where the number of vacant spaces is [1] or more, parking is permitted, and where the number of vacant spaces is [0], parking is prohibited.

The location of the parking facility extracted in Step S64 and the determined parking availability are transmitted to the subordinate 40A via the transmission unit 25 (Step S65).

Thereafter, the communication line between the transmission unit 15 and transmission unit 25 is interrupted (Step S66), and the process is terminated.

As described above, in the travel support system according to the fourth embodiment, by providing a parking D/B 43 at the side of the central computer installed on the ground and transmitting the present position of the vehicle and the vehicle information consisting of length, width and height of the vehicle from the subordinate device 40A, the display 17 displays the location of the parking facility where the vehicle can be parked, and information on whether or not the parking facility is occupied or vacant. Therefore, the driver can select the best suitable parking facility from the displayed parking facilities, and he or she can park the vehicle at the parking facility of his or her preference among the suggested available parking facilities. Accordingly, the driver can drive efficiently.

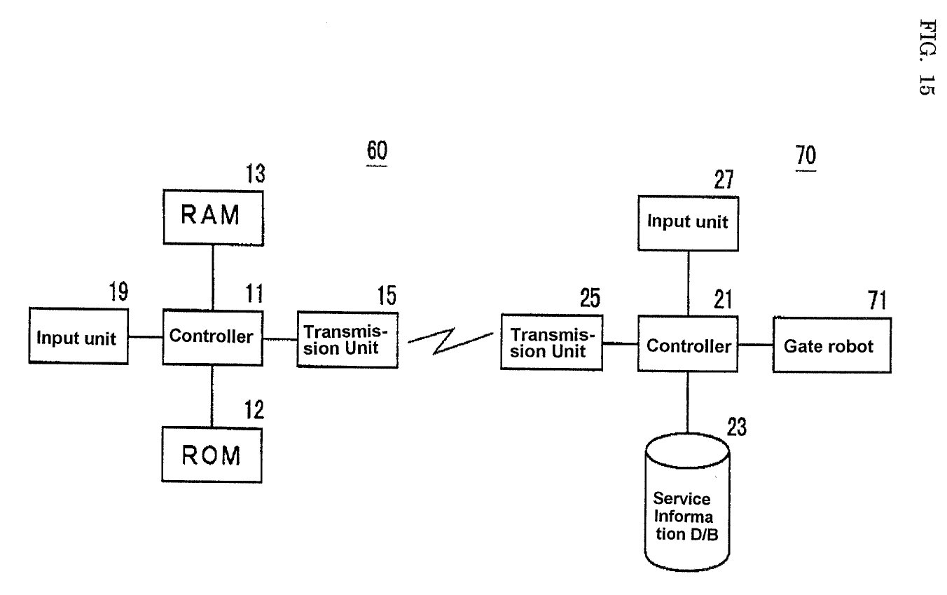

Next, a description is given of a vehicle entrance control system according to a fifth embodiment. FIG. 15 is a block diagram showing a general configuration of a vehicle entrance control system according to the fifth embodiment of the invention.

The vehicle entrance control system according to the embodiment shown in FIGS. 15(A) and 15(B) comprises a subordinate device 60 mounted in a vehicle, and a central computer 70 installed on the ground.

The subordinate device 60 of the vehicle entrance control system 60 comprises a controller 11 to control the entirety of a subordinate device 60, a ROM 12 to store vehicle information, a RAM 13 to store information on an individual, a transmission unit 15 to communicate with a central computer 70, and an input unit 19 to input specified information into the subordinate device 60.

The central computer 70 of the vehicle entrance control system comprises a controller 21 to control the entirety of the central computer 70, a service information D/B 23 to store service information, a transmission unit 25 to communicate with the subordinate device 60, an input unit 27 to input specified information into the central computer 70, and a gate robot 71.

A description of the vehicle entrance control system installed for the purpose of entrance control in a parking facility of a specified apartment house is given according to the fifth embodiment. The vehicle information stored in the ROM 12 of the subordinate device 60 is inherent to the vehicle, wherein it is assumed that the vehicle information is the type of vehicle.

The information on an individual stored in the RAM 13 pertains to the owner of a vehicle, wherein it is assumed that the information is the name of a vehicle owner.

The service information stored in the service information D/B 23 of the central computer 70 specifyes the vehicles allowed to enter the parking facility attached to an apartment house. The vehicles in the service information are specified by the names of vehicle owners and type of vehicles. Therefore, the names of owners of vehicles granted to enter the parking facility attached to the apartment house and the types of vehicles are registered in the service information D/B 23. The registration is executed by using a keyboard of the input unit 27.

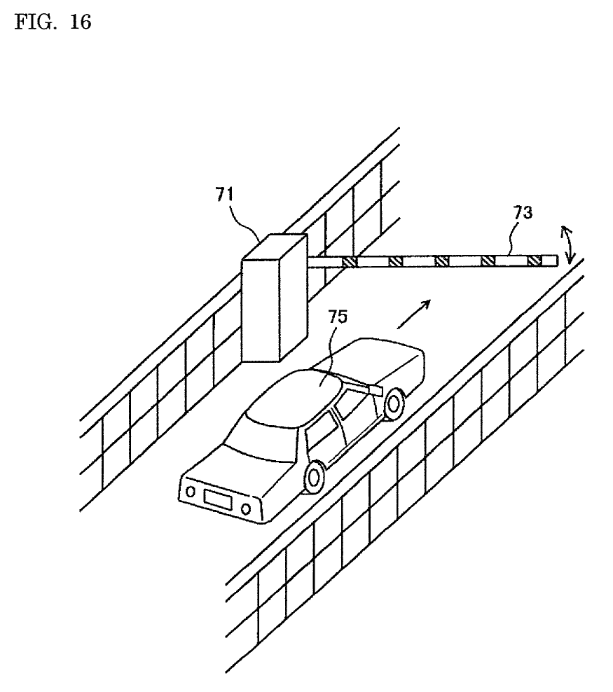

FIG. 16 is a perspective view of a gate robot 71 of the vehicle entrance control system according to the fifth embodiment. The drawing is based on a vehicle 75. The gate robot 71 operates its lifting arm 73 by turning it. When the lifting arm 73 is lowered, that is, kept horizontal, the course of the vehicle 75 is interrupted, wherein the vehicle 75 cannot pass through the lifting arm 73. On the contrary, when the lifting arm 73 is lifted up, the course of the vehicle 75 is not interrupted, wherein the vehicle can pass through the gate robot 71.

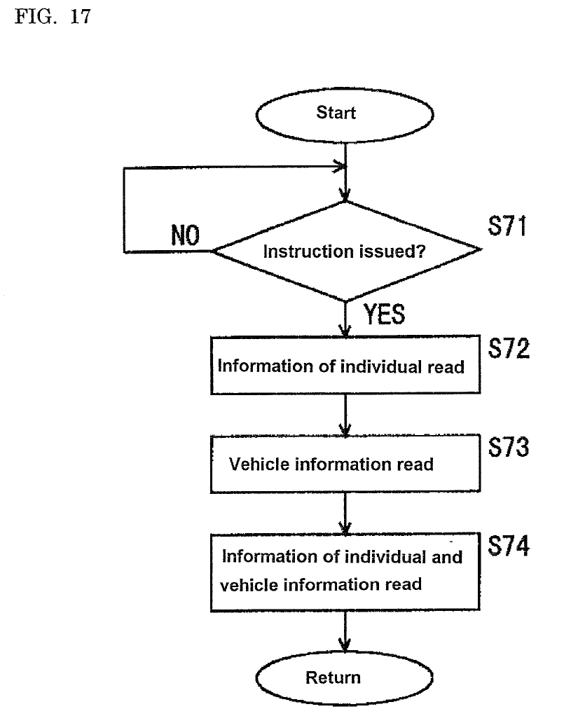

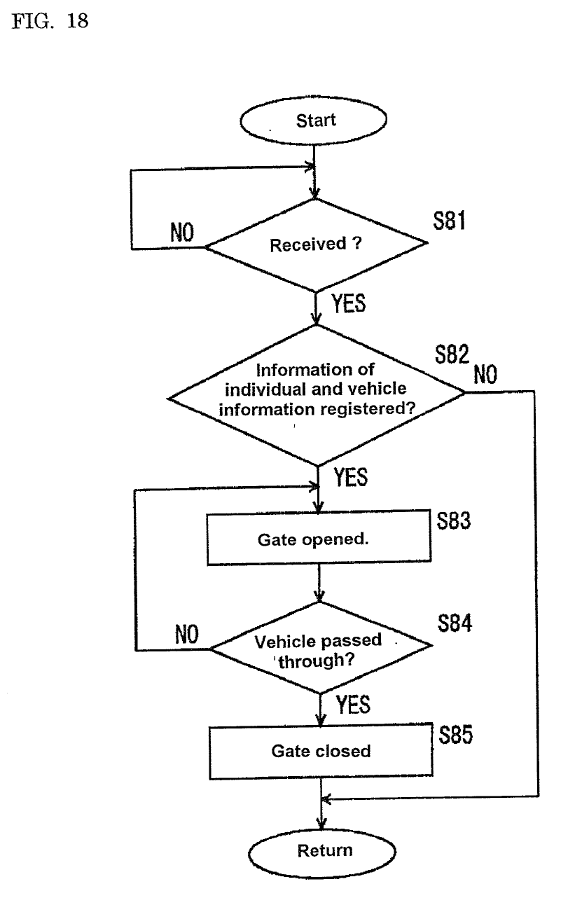

FIG. 17 is a flow chart showing a process flow carried out by the subordinate device 60 of the vehicle entrance control system according to the fifth embodiment. A description is given below based on FIG. 17. It is determined whether or not a transmission instruction is issued from the input unit 19 (Step S71). If a transmission instruction is issued, the process shifts to Step S72. If not, the process stands by until a transmission instruction is issued. Also, by generating an interrupt signal when a transmission instruction is issued from the input unit 19, the processes after Step 72 may be executed.

In Step S72, information on an individual is read from the RAM 13. The information on an individual read herein is the name of the vehicle owner.

And, the vehicle information is read from the ROM 12 (Step S73). The vehicle information read herein is the type of vehicle.

The respectively read information on an individual and on a vehicle are transmitted to the central computer 70 via the transmission unit 15 (Step S74).

FIG. 18 is a flow chart showing a process flow carried out by the central computer 70 of the vehicle entrance control system according to the fifth embodiment. A description is given below based on FIG. 18. The central computer 70 determines whether or not the central computer receives a signal from the subordinate device 60 (Step S81). If the signal is received, the process shifts to Step S82. If not, the process stands by until the signal is received. Also, an interrupt signal is generated when the transmission unit 25 detects the signal received from the subordinate device 60, and the processes after Step S82 may be carried out.

In Step S82, the information on an individual and vehicle information, which are received by the transmission unit 25, are read, and checked whether or not these are registered in the service information D/B 23. If registered, the process shifts to Step S83. If not, the process is terminated.

In Step S83, the gate robot 71 is controlled to open the gate, wherein the opening of the gate is enabled by the lifting of the lifting arm 71. And, a sensor attached to the gate robot 73 determines whether or not the vehicle passed through (Step S84). If the vehicle passed through, the process shifts to Step S85, and if not yet passed through, the process shifts to Step S83.

In Step 85, the gate robot 71 is controlled to lower the lifting arm, whereby no vehicle is permitted to enter. And the process is terminated. As described above, in the vehicle entrance control system according to the fifth embodiment, the vehicle information inherent to the vehicle is stored in an unwritable ROM 12, and information on an individual is stored in a rewritable RAM 13. Therefore, even if the vehicle owner changes, it is possible to rewrite the information on an individual easily by inputting new information on an individual through the input unit 19.

And, as the information on an individual and vehicle information are transmitted from the subordinate device 60 to the central computer 70, the central computer 70 retrieves the service information D/B 23, and determines whether or not the vehicle is permitted to enter.

The vehicle entrance control system according to the embodiment determines whether or not a vehicle is allow to based on the vehicle information and information on an individual. This makes it possible to allow only specified vehicles to enter or to pass through.

Furthermore, the information on an individual is not limited to the name of an owner. It may include the name of a driver, address and telephone number of the owner, license plate number of the vehicle, etc. Also, the vehicle information is not limited to the type of vehicle. It may include the size and grade of a vehicle, etc., or may be any information inherent to the vehicle.

All the embodiments referred to herein are only examples in all the aspects thereof, and it should not be considered that these embodiments are limitations of the invention. The scope of the invention is not shown by the above descriptions but is shown by the Claims attached herewith. Needless to say, various modifications are included in the invention with a meaning and range equivalent to the contents of the Claims.

What is claimed is:

1. A travel support system for providing information from a central computer to a vehicle-mounted subordinate device by transmission between said vehicle-mounted subordinate device and the central computer,
wherein said central computer comprises:
first memory means for storing service information pertaining to vehicle services corresponding to vehicle information pertaining to vehicles;
means for receiving vehicle information from said vehicle-mounted subordinate device;
means for reading service information corresponding to said vehicle information received by said receiving means from said first memory means; and
means for transmitting said service information read by said reading means to said vehicle-mounted subordinate device; and wherein
said vehicle-mounted subordinate device comprises:
second memory means for storing vehicle information pertaining to the vehicle; and
communication means for transmitting said vehicle information stored in said second memory means to said central computer and for receiving service information from said central computer.

2. A travel support system comprising:
a card having first memory means for storing vehicle information pertaining to vehicles;
means for detecting said card;
second memory means for storing service information pertaining to vehicle services corresponding to vehicle information;
first reading means for reading the vehicle information from said first memory means in response to having detected said card by said detecting means;
second reading means for reading the service information corresponding to the vehicle information read by said first reading means from said second memory means; and
means for outputting the service information read by said second reading means.

3. A travel support system comprising:
first memory means for storing vehicle information pertaining to vehicles;
means for acquiring the current position of a vehicle;
second memory means for storing information about the locations of a plurality of parking areas and information about vehicle services for the respective parking areas corresponding to vehicle information;
means for selecting an adequate parking area from said second memory means based on the vehicle information stored in said first memory means and the current vehicle position acquired by said acquiring means; and
means for conveying information about the location of available parking area, which is selected by said selecting means.

4. A vehicle entrance control system for permitting entrance or pass-through of a vehicle by communication between a vehicle-mounted subordinate device and the central computer set on the ground;
wherein said vehicle-mounted subordinate device comprises;
first memory means for storing vehicle information pertaining to the vehicle;
second memory means for storing information of an individual pertaining to the owner of a vehicle; and
means for transmitting the vehicle information stored in said first memory means and information stored in said second memory means to said central computer; and
said central computer comprises;
a gate that permits or prohibits a vehicle to pass through;
third memory means for storing information showing permission or prohibition of the pass-through of a vehicle, corresponding to the information on an individual and vehicle information;
means for receiving the vehicle information and information on an individual that are transmitted from said transmitting means;
means for reading, from said third memory means, the information showing permission or prohibition of the pass-through of a vehicle corresponding to the vehicle information and the information on an individual that are received by said receiving means; and
gate controlling means for changing the state of the gate in response to the information showing permission or prohibition, which is read by said reading means.
